(19) United States
(12) Patent Application Publication
(10) Pub. No.: US 2003/0015852 A1
(43) Pub. Date: Jan. 23, 2003

(54) Wheelbarrow with multiple wheels, a pulling ring and a parking brake

(76) Inventor: Edgar Leon Swift, Roswell, GA (US)

Correspondence Address: EDGAR L. SWIFT, 1596 SANDPOINT DRIVE, ROSWELL, GA, 30075, US

(21) Appl. No.: 10/106,296

(22) Filed: Mar. 25, 2002

Related U.S. Application Data
(63) Continuation-in-part of application No. 09/904,304, filed on Jul. 12, 2001, now abandoned.

(51) Int. Cl. B62B 3/00

(52) U.S. Cl. 280/47.34

(57) ABSTRACT

An improved wheelbarrow with a design and method of use that departs significantly from that of conventional wheelbarrows. It has a wheel-fitted undercarriage assembly in place of the rear struts normally associated with conventional wheelbrrows. The use of the wheel-fitted undercarriage enables a user of this wheelbarrow to traverse obstacles in the path of the wheelbarrow's travel more easily by pushing down on the handles of the wheelbarrow and pushing forward on it using the rear wheels. This wheelbarrow also has a parking brake to prevent it from coasting unsafely on its own, and a pulling ring that allows one person or vehicle to pull the wheelbarrow while another person pushes and guides it.

This is a Continuation-In-Part (CIP) of application Ser. No. 09/904,304, Filed Jul. 12, 2001, which is to be abandoned as an act of this submission. This CIP offers significant improvements over the parent application, but does not define subject matter that is unobvious over that of the parent application. Specifically, the improvements are a brake shoe on each of the rear wheels rather than on just one for improved braking action; a repositioned brake lever for easier user access, a positive detent to lock the brake in either the “On” or “Off” position more securely and optional knobs affixed to the handles to provide a more positive grip for the user when pulling the wheelbarrow by its handles. These knobs constitute an obviously necessary embodiment for a wheelbarrow of this design, since it will be used to move heavy loads when traversing obstacles by pulling the wheelbarrow in reverse. Additionally, this CIP changes the wording of the title to more nearly describe the essence of the invention, reduces the number of figures describing the invention and replaces the photographs with line drawings.

### BACKGROUND

1. Field of the Invention

This invention relates to wheelbarrows. More particularity, it relates to wheelbarrows comprised of a cargo pan (barrow) mounted to two handles that project rearward beyond the cargo pan that allow a user to control the movement and direction of the device. Such wheelbarrows usually have one or more wheels installed on a shaft secured to the front of the handles and have two vertically mounted “U-shaped” struts placed underneath and towards the rear of the cargo pan to enable the wheelbarrow to stand upright when it is at rest.

2. Description of Prior Art

There is a multitude of designs of wheelbarrows known in the prior art. Only the type described under the heading: “ . . . Field Of The Invention” will be dealt with in this application. One commonality among prior art wheelbarrows as described above is that they all typically have only one point of useful leverage, which is realized by using the axle of the front wheel(s) as a fulcrum in conjunction with the user raising the rear ends of the handles of the wheelbarrow to lift its load for transporting.

Conventional wheelbarrows perform well when being pulled or pushed over a surface that has no obstructions of significant height or depth, relative to the diameter of their front wheel(s), in their path of travel. Such obstructions could be curbs, logs, steps, trenches or holes, for example. When a user pushing a conventional wheelbarrow confronts such an obstruction and can't move around it, he or she can sometimes traverse it by “ramming” into it with the front wheel(s) of the wheelbarrow and bouncing up over or across it if the obstacle is no more than about three inches high. This often leads to the wheelbarrow tipping over, causing it to spill its load. An equally devastating consequence can occur if the wheelbarrow is being used, in the situation just described, to transport fragile cargo even if it doesn't tip over.

When the user of a conventional wheelbarrow determines that it is either unwise or impossible to push or ram the wheelbarrow over or across an obstruction, he or she will usually make the choice of turning the wheelbarrow around and pulling it either up and over the obstruction if it is a raised one or down and up through it if it is a depression, such as a hole or trench. When this becomes necessary, the user of the conventional wheelbarrow has to exert enough force to overcome two sources of resistance: 1) The obstruction that the user is trying to traverse with the wheelbarrow presents a virtually infinite source of resistance to progress of the wheelbarrow in the desired direction. 2) The force of gravity provides a source of resistance working downwardly against the mass of the wheelbarrow and its cargo. Because of this, the user has to lift both the wheelbarrow and its cargo upward to traverse the obstruction. Even in the case of a hole or trench, the user can allow the front wheel(s), by pulling back on the handles, to gently move down into the depression, but he or she would still have to lift the wheelbarrow out of it once it gets to the far side.

In the situations just mentioned, the conventional wheelbarrow not only loses part of the utility of its valuable attributes, it is an impediment to its user, because its user has to exert enough upward force to haul the weight of both the wheelbarrow and its cargo over the obstruction without the advantage of leverage. It is only after the user has suffered the stress of exerting this unleveraged force to get the wheelbarrow over or through the obstruction that the advantages of the conventional wheelbarrow again become apparent.

All conventional wheelbarrows have two fulcrums of leverage. The axle of the front wheel(s) is the fulcrum of leverage when the user lifts the rear of the handles of the wheelbarrow in order to raise its load of cargo to the transporting position. This is useful leverage and is partly what has made the conventional wheelbarrow the important tool that it is. The second fulcrum of leverage is constituted by the bottom of the struts, usually located underneath and towards the rear of the device. This leverage comes into play when the user pushes down on the wheelbarrow's handles causing its front end to rise. Although this leverage facilitates raising the front end of the wheelbarrow, it is usually useless leverage, because it removes the wheelbarrow's front wheel(s) off the surface and this puts it in a position in which it can't be easily moved, thus impeding the transport of its load. The wheelbarrow can't be easily moved when in this position, because removing its front wheel(s) from the surface transfers the combined forces of its weight, the weight of its cargo and the force of the user pushing down onto the relatively immovable struts, which are usually going to be sitting on a surface that has a high coefficient of sliding friction. Since wheelbarrows are designed to transport loads; employing the use of one or more wheels; either horizontally or up or down an inclined plane, little value can be realized from using its leverage to move its front wheel(s) vertically off a surface.

A further limitation of conventional wheelbarrows is that they have no provisions incorporated into their design for more than one person to operate the wheelbarrow when using it to move an extremely heavy load or when moving a load up a steep incline.

Although during my patent searches I was unable to find any wheelbarrows designed to overcome the aforementioned short-comings, I did find some with embodiments that could, at first glance, cause them to appear to be patentably the same as the present wheelbarrow. Therefore I will describe each of them and their shortcomings briefly below:

One invention using a three-wheel design is U.S. Pat. No. 5,509,681 to Keller issued Apr. 23, 1996. It is actually a kit for converting a wheelbarrow to a garden cart to be pulled by a vehicle, such as a garden tractor. It relies on the vehicle that it is attached to for a source of “braking” while it sits at rest. Because of this, it can not function safely on its own as a wheelbarrow. Its claims do not mention its being intended for use in the manner that the present wheelbarrow will be used and later described.

Another invention using a three-wheel design is U.S. Pat. No. 6,241,276 to Wilburn issued Jun. 5, 2001. This invention, which claims a way of modifying a wheelbarrow to be used like a truck, has no embodiment such as a hitch or pulling ring for pulling it like a truck or for pulling it in the manner that will be described for the present invention. It has no parking brake for allowing it to be used safely as a wheelbarrow. The positioning of its rear wheels is quite far behind its center of gravity because of the manner in which the mounting shafts for the wheels are attached and positioned on the assembly. These embodiments would appear to render it difficult for this invention to be used in the manner that will be described for the present invention. It's claims make no mention of it being designed to be used in the manner that will be described for the present invention.

A third invention using three wheels and a parking brake is U.S. Pat. No. 6,220,622 to Garcia, Issued Apr. 24, 2001. This invention discloses the use of large swivel casters for the two rear wheel assemblies. It further specifically claims that the swivel feature of the casters is to be offset from the vertical centerline of the swivel's spindle. While swivel casters may likely keep the wheelbarrow standing upright when all three wheels are on a resting surface, the wheelbarrow is likely to tip over if it is allowed to rest on only the two rear casters in the manner that will be described for the present invention. This is because the invention has no provision for positioning the casters so that they are simultaneously pointing in the same direction. If one caster has its “toe” pointing towards the front of the wheelbarrow and the other caster has its “toe” pointing in another direction, for example, the wheelbarrow and its load will be thrown off balance when the handle is pressed down to cause the front wheel to raise off the resting surface as will be described later in respect to the present wheelbarrow.

The hinged braking mechanism on this invention has an operational reliability exposure. If it is installed as shown in FIG. 4 of the disclosure, it wouldn't take a great deal of backward motion of the wheelbarrow (such as from throwing an object into it, rather than gently lying it in place) for the brake to be jarred out of the locked position—especially since it is already biased towards the unlocked position by the coil spring. This invention makes no claims of being intended for use in the manner that will be described for the present invention.

A fourth invention using two rear wheels and a gravity operated parking brake is U.S. Pat. No. 4,767,128 to Terhune, issued Aug. 30, 1988. This invention discloses the use of large swivel casters for the two rear wheel assemblies. According to the drawing figures shown in this invention, the swivel casters are straight, rather than offset. That design would render this wheelbarrow practically impossible to steer if it were riding on either all three wheels or on just the two rear wheels. The gravity operated parking brake on this wheelbarrow would also render it difficult to use in the manner that will be described for the present wheelbarrow, since moving the wheelbarrow in reverse while it is riding on its two rear wheels or all three wheels would not dislodge the brakes, as has been observed by that inventor. He states that either lifting the rear handles or pushing the wheelbarrow forward would cause the brakes to become dislodged.

### SUMMARY OF THE PRESENT INVENTION

In view of the foregoing short comings inherent in the design of the types of prior art wheelbarrows cited above, the present invention discloses an improved wheelbarrow with increased safety of operation, stability and efficiency. As such, the general purpose of my present wheelbarrow, which will be described subsequently in greater detail, is to enable its user to traverse obstacles in its path more easily; facilitate hauling heavy loads and provide a safe, reliable braking system that can be detented securely in the “On” or “Off” position.

### OBJECTS AND ADVANTAGES

To attain the objects and advantages stated in the foregoing summary, the present wheelbarrow incorporates and utilizes embodiments that increase its efficiency, stability and operational safety over wheelbarrows of the prior art. It can be built by replacing the rear strut assembly of a typical conventional wheelbarrow with a wheel-fitted undercarriage assembly which incorporates a parking brake that can be positively detented in either the “On” or the “Off” position. Some of the objects and advantages of my present wheelbarrow are:

(a) To provide a wheelbarrow that is capable of enabling its user to efficiently traverse obstacles with it that are in its path of travel;

(b) to provide a wheelbarrow that is capable of enabling its user(s) to haul a heavier load than can be hauled by a conventional wheelbarrow;

(c) to provide a wheelbarrow that is capable of being pulled by one person (or by a vehicle) while another person pushes and guides it;

(d) to provide a wheelbarrow that incorporates a parking brake which enables it to sit, either loaded or unloaded, on an inclined surface without “coasting” on its own;

(e) to provide a wheelbarrow with a positive detent for locking its parking brake in either the “On” or “Off” position;

(f) to provide a wheelbarrow that has a brake operating lever that is conveniently located for ease of operator access and use;

(g) To provide a wheelbarrow that can be easily developed and built at low cost by those currently manufacturing conventional wheelbarrows;

(h) to provide a wheelbarrow that can be marketed by a manufacturer of conventional wheelbarrows to its existing distributrion channels with its existing sales force;

(i) to provide a wheelbarrow that, although richer in function than conventional wheelbarrows, still looks and performs like a “wheelbarrow”.

A further object and advantage is to provide a wheelbarrow that incorporates new, useful, nonobvious features into a wheel-fitted assembly that can easily replace the strut assemblies currently used on conventional wheelbarrows. Still further objects and advantages will become apparent from a consideration of the ensuing descriptions and drawings.

### DRAWINGS

FIG. 1 is an isometric view of the present wheelbarrow as viewed from its left side.

FIG. 2 is a partial view of the present wheelbarrow with its pan removed to reveal the embodiments associated with the parking brake.

FIG. 3 is an enlarged view showing how the parking brake lever is attached to the brake locking bracket.

FIG. 4 is a view of some of the brake embodiments taken along line 4—4 of FIG. 3.

Reference Numerals In Drawings

| | | | |
|---|---|---|---|
| 3 | Sectional View To Be Enlarged | 4 | Fragmentary Sectional View |
| 10 | Pulling Ring | 12 | Cargo Pan * |
| 14 | Handles (2) * | 16 | Optional Handle Knobs (2) |
| 18 | Front Wheel(s) * | 20 | Rear Wheels (2) |
| 22 | Rear Wheel Shaft | 24 | Wheel Mounting Brackets (2) |
| 26 | Brake Lever | 28 | Brake Locking Bracket |
| 30 | Brake Locking Slot | 32 | Brake Locking Stud |
| 34 | Brake Shoe (2) | 36 | Brake Shaft |
| 38 | Bushing (2) | 40 | Bellcrank |
| 42 | Pivot Stud | 44 | Mounting Screws |

(* Denotes Prior Art)

### DESCRIPTIONS OF THE PREFERRED EMBODIMENT

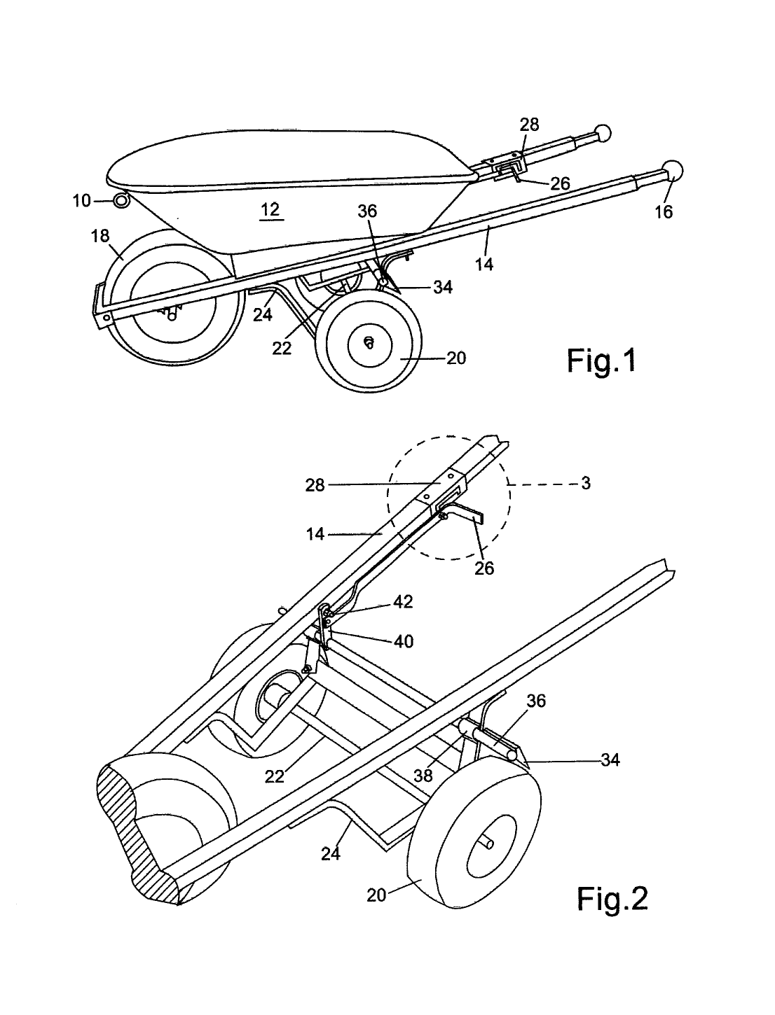

Description—FIG. 1

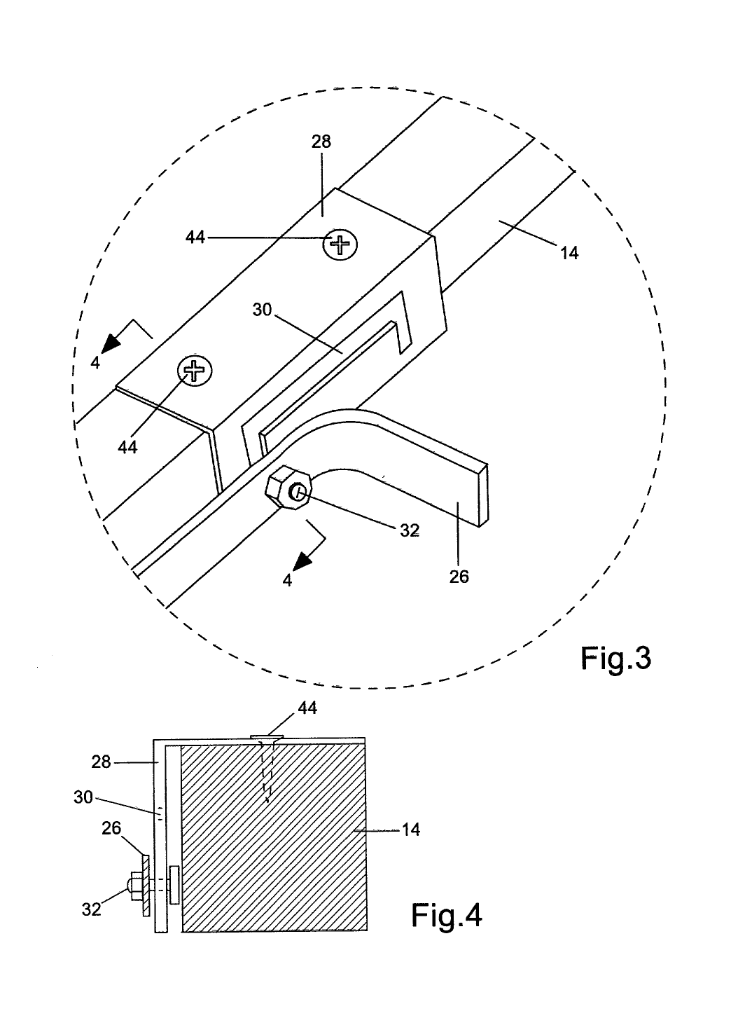

FIG. is an isometric view of the Left side of the present wheelbarrow with references pointing only to those embodiments that will be referred to subsequently in this application. If a part is not shown or mentioned, it is assumed that those skilled in the art will understand how it fits into the design of this type of product. An optional pulling ring 10 has been attached to the front of the wheelbarrow. Its primary purpose will be to allow someone to pull the wheelbarrow while someone else uses the handles 14 to push the wheelbarrow and guide it in situations in which an extremely heavy load has to be transported, or the wheelbarrow and its cargo has to be moved up a steep incline. To enable the present wheelbarrow's use in this manner, two rear wheels 20 have been added to work in conjunction with one or more front wheels 18 to provide support for the heavy load. The two rear wheels 20 are mounted to a rear wheel shaft 22 that is rigidly affixed to wheel mounting brackets 24 installed underneath a cargo pan 12 and on each side of the wheelbarrow. The height of these brackets is such as to allow the wheelbarrow to stand upright with a posture that is generally considered “normal” when it is at rest. In the case of my prototype, I'm using 10-inch diameter rear wheels 20, so the height of the brackets 24 would take that dimension into account. Those skilled in the art will recognize that the position of the mounting holes in the brackets 24 can coincide with the position of the strut mounting holes on a conventional wheelbarrow. A brake shoe 34 is rigidly affixed to each end of a brake shaft 36 which is pivotably mounted to the wheel mounting brackets 24 using bushings 38 that will be described in FIG. 2. A brake lever 26 and its brake locking bracket 28 are affixed to one of the handles 14 in a position to be easily accessed by the user. FIGS. 2 and 3 will provide greater detail describing the workings of these components.

Description—FIG. 2

FIG. 2 is a partial view of the present wheelbarrow with its cargo pan 12 removed to reveal and describe the embodiments of the parking brake. The brake lever 26 is attached to a bellcrank 40 using a pivot stud 42 that can be either riveted or affixed in place using a variety of alternative mechanical connection methods, such as a locking nut. The brake lever 26 is attached to the brake locking bracket 28 by a brake locking stud 32, which will be shown in greater detail in an enlargement of the sectional view 3 that will be shown in FIG. 3. The bellcrank 40 is rigidly attached to the brake shaft 36, so that it can rotate the shaft 36 inside the bushings 38 when the lever 26 is operated, resulting in pivoting the brake shoes 34 either against or away from the tread of the wheels 20. Since the brake shoes 34 are rigidly attached to the same wheel mounting brackets 24 as the wheel shaft 22 is mounted, positive brake action can be effected without torsional distortion of the wheel brackets 24, which could decrease the effectiveness of the brakes.

This view also shows the two rear wheels 20 mounted onto the rear wheel shaft 22. No detail of the mounting hardware has been shown, since those skilled in the art clearly understand the various ways of mounting a wheel to a shaft and using the appropriate spacers to prevent the inside of the wheels 20 from rubbing the wheel mounting brackets 24.

Description—FIG. 3

FIG. 3 is an enlarged view of the brake lever 26 and associated components. This view shows how a brake locking stud 32 is fitted into a brake locking slot 30 that is cut into the brake locking bracket bracket 28. The channel of the brake locking slot 30 is narrower than the diameter of the head of the locking stud 32, so that the stud can not pull out of the bracket 28 once the parts are assembled, as will be more clearly shown in FIG. 4. Although a locknut, shown but not labeled in this view, is used to mount the stud 32, alternative mechanical connection methods such as shouldered rivets, etc. could be used that those skilled in the art would understand and appreciate.

Description—FIG. 4

This view shows the mounting of the brake lever 26 to the brake locking bracket 28 using the locking stud 32. It shows the bracket 28 attached to the handle 14 by screws 44, but alternative attachment methods could also be employed.

Operation of the Preferred Embodiment

The present wheelbarrow can be used identically the same way that one would use a conventional wheelbarrow if the brakes are set in the “On” position. Referring to FIG. 3, the brakes are set in the “On” position by pulling the brake lever 26 back until the locking stud 32 contacts the rear of the slot 30 in the locking bracket 28, then pushing the lever 26 down causing the locking stud 32 to move down into the rear detent of the locking slot 30. This is the position that the brakes should be set in when the wheelbarrow is being loaded or resting on an unlevel surface.

When using the wheelbarrow to traverse an obstacle in its path, such as a curb, a step, a log, etc., the user would move the brake lever to the “Off” position. This is done by lifting up on the lever 26 and moving it to the front of the slot 30 in the locking bracket 28, then pushing it down so that the locking stud 32 “bottoms out” in the forward detent of the locking slot 30. When in this position, the user would move the wheelbarrow forward until its front wheel (s) 18 meet the obstacle. The user would then press down on the wheelbarrow handles 14 until the front wheel(s) 18 is raised high enough to clear the obstacle. The user would then push the wheelbarrow forward with it riding on its rear wheels 20. Once the front wheel(s) 18 clear the obstacle, the user can then allow those wheels to settle down on the far surface and then raise the handles 14 to a height that would lift the rear wheels 20 to clear the obstacle and move forward using the front wheel(s) 18 or all wheels, depending on the situation. By reversing this procedure, the present wheelbarrow can also be used to traverse an obstacle while moving the wheelbarrow in reverse.

When moving an extremely heavy load or moving a load up a steep incline, the user can push the wheelbarrow without raising its handles 14 and use the rear wheels 20 in conjunction with the front wheels 18 to distribute the load. Another person could also assist in moving such a load by attaching a rope, cable, chain, vehicle, etc. to the pulling ring 10 and pull the wheelbarrow while someone else use the wheelbarrow handles 14 to push it and guide it.

### CONCLUSION

Accordingly, one can see that there are significant advantages to replacing the rear struts found on typical conventional wheelbarrows with widely spaced, relatively large diameter wheels. Such a design not only facilitates the user's ability to traverse obstacles with the wheelbarrow, it also increases both the load bearing capacity as well as the load carrying capacity of the wheelbarrow.

Those who are familiar with using a conventional wheelbarrow will readily see that the present wheelbarrow enables its user to transport heavy loads in a manner that would be virtually impossible for a user to transport using a conventional wheelbarrow. The incorporation of a pulling ring on the present wheelbarrow would allow one person, with or without a vehicle, to pull the wheelbarrow while another person uses the handles to push and guide it. The incorporation of “non-slip” knobs on the handle ends allow a person to pull a heavier load in reverse with the wheelbarrow with less risk of the handles slipping out of the user's grip. This embodiment is especially important when the wheelbarrow is being pulled in reverse to traverse an obstacle as described under the “Operations” section of this specification. Such a wheelbarrow would not be safe or practical without a reliable parking brake that is easy to use and has positive detenting for both the “On” and “Off” braking positions. Therefore, such a feature has been incorporated into the design of the present wheelbarrow.

Development, manufacturing and distribution costs are important, because of the impact that they ultimately have on the price of a product to the consumer. Those costs have been minimized in designing the present wheelbarrow by using a conventional wheelbarrow as the basis for the present invention. Close scrutiny by one skilled in the art would reveal that the design and manufacturing changes needed to modify a conventional wheelbarrow to meet the capabilities of the present wheelbarrow are minimal. Further, the present wheelbarrow can be assembled by the existing employees of a manufacturer of conventional wheelbarrows with very little training and it can be built on the same assembly line that the manufacturer already has in place. A manufacturer that currently builds conventional wheelbarrows could easily incorporate the present wheelbarrow into its offerings and market it through its current distribution channels with its existing sales force. All of these considerations give the manufacturer the ability to expand its consumer offerings by incorporating the present wheelbarrow into its product line at minimal cost.

It will be understood that while the form of the invention herein shown and described constitute preferred embodiments of the invention, it is not intended to illustrate all possible forms of the invention. It will also be understood that the words used throughout this application are words of description rather than words of limitation and that various changes may be made without departing from the spirit and scope of the invention herein disclosed and claimed.

What is claimed is:

1. A wheelbarrow comprised of:
a cargo pan attached to the upper side of two handles that extend beyond the rear of said cargo pan;
said two handles have optional knobs on their hand-grips to enable pulling said wheelbarrow without the user's hands easily slipping off said handles;
one or more wheels attached to the front end of said wheelbarrow;
two rear wheels positioned beneath the cargo pan of said wheelbarrow and widely spaced on an axle, so that the imaginary perpendicular plane of the outer walls of said wheels coincide with or nearly with the imaginary perpendicular plane of the sides of the cargo pan of said wheelbarrow;
a parking brake that enables the locking of at least one of said rear wheels to prevent or impede the rotation of said rear wheel(s);
a parking brake actuating means that enables shifting the position of said parking brake between the “On” and “Off” positions;
said parking brake actuating means has means to positively lock it selectively in either the “On” or the “Off” positions;
said parking brake actuating means is positioned for easy access by the user;
an optional pulling ring.

2. A wheelbarrow that, when using it, enables its user to traverse obstacles with it more easily than can be done using a conventional wheelbarrow.

3. The wheelbarrow of claim 2 wherein it enables its user to traverse obstacles by rolling said wheelbarrow forward up to the obstacle, depressing the rear handles of said wheelbarrow causing its front wheels to clear the obstacle, then pushing said wheelbarrow forward with it riding on its rear wheels.

4. The wheelbarrow of claim 2 wherein it enables its user to traverse obstacles by rolling said wheelbarrow in reverse up to the obstacle, raising rear handles of said wheelbarrow causing the rear wheels to clear the obstacle, then pulling said wheelbarrow backwards with it riding on its front wheel(s).

5. The wheelbarrow of claim 2 wherein it incorporates an optional pulling ring to facilitate the transport of heavy loads.

6. The wheelbarrow of claim 2 wherein it has a braking means to facilitate control of its movement.

7. The wheelbarrow of claim 2 wherein the handles of said wheelarrow have means to preclude the hands of the user of said wheelbarrow from easily slipping off said handles when pulling a load in reverse using said wheelbarrow.
